(19) United States
(12) Patent Application Publication
(10) Pub. No.: US 2005/0145249 A1
(43) Pub. Date: Jul. 7, 2005

(54) Personal respiratory protection device that has a permanent or semi-permanent bayonet connection

(76) Inventors: Alan J. Solyntjes, Edina, MN (US); Floyd L. Foslien, Hudson, WI (US); Benjamin A. Johnson, Woodbury, MN (US)

Correspondence Address: 3M INNOVATIVE PROPERTIES COMPANY, PO BOX 33427, ST. PAUL, MN, 55133-3427, US

(21) Appl. No.: 10/750,077

(22) Filed: Dec. 31, 2003

(51) Int. Cl. A62B 18/02; A62B 7/10

(52) U.S. Cl. 128/205.25; 128/206.16; 128/206.17

(57) ABSTRACT

A personal respiratory protection device that has a bayonet attachment system. The bayonet attachment system comprising a first portion and a second portion, wherein the first portion comprises a tab receptacle and a tab void area, and the second portion comprises a tab extending therefrom. The tab has a size no greater than the tab void area and no greater than the tab receptacle. When the first portion is attached to the second portion to cause the tab to seat within the tab receptacle, a connection is formed that is incapable of being inadvertently removed.

The present invention pertains to a personal respiratory protection device that has an attachment system that inhibits inadvertent removal of an engaged bayonet-style component. The personal respiratory protection device may be, for example, a respirator that has attached filter cartridges.

### BACKGROUND

Respirators and other types of respiratory protection equipment have been used to protect wearers from breathing airborne contaminants such as suspended particulates, toxic fumes, organic vapors, biological hazards, and the like. Many types of respiratory equipment are known for providing clean air to the wearer. This equipment may include full face respirators, half mask respirators, supplied air hoods, powered air purifying respirators (PAPRs), and self contained breathing apparatus (SCBA), including full containment suits. The particular equipment selected for use may vary with the ambient environment, the contaminant to be removed, and the amount of contaminant desired to be removed.

A common personal respiratory protection device is known as a “respirator”, which may be furnished to the user in either a half-face or full-face configuration. A half-face or half-mask respirator, such as shown in FIG. 1, fits over a person's nose and mouth, whereas, a full-face respirator covers the eyes as well. Using either kind of mask, a soft, compliant rubber is regularly used to form a tight seal against the wearer's face to eliminate air leakage between the respirator and the face. Incoming air is commonly passed through a filter, typically either a single filter centrally located at the front of the mask or a dual filter that is located at each side on the cheek area. The filter(s) may be, for example, a cartridge that contains activated carbon to remove organic vapors from the air, a non-woven filter that has electrically-charged fibers to remove particulate material, or a combination of the two. The filter cartridges are commonly removable and replaceable from the mask body.

The mask bodies have fittings for receiving the filter cartridge(s). The fittings and cartridges sometimes have complementary mating threads that permit filter cartridge to be screwed or threaded into position. When these replaceable filter cartridges are secured to the mask, however, opportunities exist for air leakage to occur if the cartridge is improperly cross-threaded or is not screwed on sufficiently tight. Threaded cartridges are typically circular in shape to facilitate rotational attachment during mounting.

Alternatively, a filter cartridge may be attached to a face mask using a “bayonet” system. A bayonet system also uses rotation to mount the cartridge but typically does not employ threads and does not need multiple turns to secure the cartridge to the mask body. In a bayonet system, a quick rotational turn, for example, a 45 to 90 degree turn, can attach the cartridge to the mask. Sometimes the bayonet cartridge is oblong in shape to aid in seating and turning, but circular cartridges may also be used. A plurality of tabs, typically three, are present on the outer surface of the cheek fitting, each of which corresponds to a notch, or tab receptacle, formed in the bayonet cartridge. When the tabs are aligned with the notches, the cartridge can be positioned in place and rotated for attachment. The tabs and corresponding tab receptacles are typically designed to allow only one orientation of the cartridge on the mask body. The bayonet cartridges are very popular with respirator wearers because the cartridges can be easily removed and replaced with a simple twist. Commercial products that use a bayonet system for securing filter cartridges include the 6000 Series™ and 7000. Series™ respirators sold by the 3M Company of St. Paul, Minn.

A bayonet-type system is also described in U.S. Pat. Nos. 4,850,346 and 4,934,361. These patents describe the use of such a system to attach filter cartridges to an inhalation valve fitting on a respiratory mask. To connect the filtration cartridges to the inhalation valve fittings, an audible detent means is used to indicate when each cartridge is properly secured to the respiratory fitting. As the parts are rotated relative to each other, deflections of a rib and lug occur until the rib abruptly drops off the end of a cam, producing an audible click. The cam and rib yieldably hold the cartridge in position so that the cartridge cannot be uncoupled unless a positive and deliberate torque is applied.

Occasions may arise, however, where a positive torque could be inadvertently applied to a cartridge on a mask. The cartridge could bump or rub against an adjacent object when the wearer moves, causing the cartridge to twist and become loosened from the facepiece. In some applications, where tight quarters or other personal protective equipment is present, a system to permanently lock the cartridges in place may be desirable. When the wearer is working in a very hazardous environment, opportunities for inadvertent cartridge loosening must be avoided. The invention described below addresses a security feature that enables the wearer to be confident that the bayonet connection has been seated correctly and that the connection cannot be inadvertently loosened.

### SUMMARY OF THE INVENTION

In brief summary, the present invention provides a personal respiratory protection device that comprises:
(a) a mask body that is adapted to fit at least over a person's nose and mouth;
(b) at least one fluid communication component located in fluid communication with the mask body so that a non-contaminated source of oxygen can be supplied to a wearer of the personal respiratory protection device;
(c) at least one non-contaminated breathing gas supply source component; and
(d) at least one bayonet attachment system that enables the breathing gas supply source component to be fluidically communicatively secured to the fluid communication component. The bayonet attachment system comprises a first portion and a second portion, wherein when the first portion is attached to the second portion with a connection that is incapable of being inadvertently separated.

The present invention provides a security feature for coupling personal respiratory protection device components that utilize a bayonet-style attachment system. The security feature inhibits accidental disengagement of the bayonet connection, and, in some embodiments, eliminates disengagement. The connection cannot be loosened or unlocked without destructive breaking of a portion of the bayonet attachment system or without use of a key. The connection therefore cannot be inadvertently disengaged or unlocked through accidental positive torque. Such a connection is referred to herein as a “permanent”, “locked”, or “locking” connection. Once disengaged, the bayonet connection is disabled and inhibits future connections unless a semi-permanent connection is provided whereby a separate key or tool is needed to intentionally disengage the securing feature.

The inventive bayonet attachment system thus provides a more secure coupling of personal respiratory components, so that the positive disengagement cannot inadvertently happen. Additionally, sabotage or misuse of spent or contaminated components can be avoided.

The invention also may allow for improved workplace management of the respiratory equipment.

The attachment system incorporating the security feature may be used in the full range of personal respiratory protective equipment. The attachment system can be used, for example, to couple respirator cartridges or hoses to the face piece of a respirator, to couple a PAPR blower to attachments such as hoses and filter cartridges, and to secure SCBA air sources to air supply components.

### Glossary

The following terms, as used in reference to the invention, are defined as set forth below:
“bayonet attachment system” or “bayonet locking system” is a system configured for attaching two portions together, where the two portions include elements other than mainly threads such that the two portions are attached by inserting one portion at least partially within the other portion and rotating one portion relative to the other so that the two portions can be joined without multiple turns;
“cannot be or incapable of being inadvertently removed or separated” means that the first and second portions are permanently joined or can be only separated through use of a key that unlocks the first and second portions without breaking or destroying either portion or a part that is used to provide a connection between such portions, which connection is only non-destroyingly separable by the key thereof;
“key” means implement, device, element, or input that functions, as intended, for unlocking the first and second portions of the bayonet attachment system;
“non-contaminated air or oxygen” means air that has been filtered or that has otherwise been processed to ensure that the supplied air or oxygen is safe to breath by a person;
“non-contaminated breathing gas supply source component” means a device or apparatus that is capable of providing non-contaminated air or oxygen to a wearer of a personal respiratory protection device;
“permanent” or “permanently” is intended when a connection between several pieces cannot be undone without breaking or destroying at least one piece;
“personal respiratory protection device” is a device or equipment known for providing clean or cleansed air or oxygen as breathing air to a user; this equipment includes full face respirators, half mask respirators, supplied air hoods, powered air purifying respirators (PAPRs), and self contained breathing apparatus (SCBA); and
“to break” or “to destroy” a bayonet attachment system means that the bayonet attachment system is inoperable to connect and lock the two portions, as is customary for the bayonet attachment system and/or that the portion of the system does not retain its original configuration to serve its intended function.

### BRIEF DESCRIPTION OF THE DRAWING

The invention may be better understood by reference to the drawings, wherein:

FIG. 1 is a perspective view of a half-face respiratory mask 10 that has filter cartridges 18 attached to a mask body 11;

FIG. 2 is an exploded view of an interior of a cartridge housing 20 of a filter cartridge 18 such as shown in FIG. 1 and a male bayonet cartridge attachment fitting 30;

FIG. 3 is a top plan view of the cartridge housing 20 as shown in FIG. 2;

FIG. 4 is a perspective view of a locking device 40 according to the present invention;

FIG. 5 is a perspective view of a modified embodiment of a locking device 40′ according to the present invention;

FIG. 6 is a perspective view of the locking device 40 of FIG. 4 positioned on a bayonet cartridge housing 20 of FIG. 2;

FIG. 7 is a perspective view of a further embodiment of a locking device 70 according to the present invention;

FIG. 8 is an enlarged view of a catch mechanism 90 of the locking device 70 shown in FIG. 7, with a tab 36 from a bayonet cartridge attachment shown in phantom;

FIG. 9 is a perspective view of yet a further embodiment of a locking device 70′ according to the present invention;

FIG. 10 is an enlarged view of a catch mechanism 90′ of the locking device 70′ shown in FIG. 9, with a tab 36 from a bayonet cartridge attachment shown in phantom;

FIG. 11 is a perspective view of yet a further embodiment of a locking device 70″ according to the present invention;

FIG. 12 is a top plan view of the locking device 70″ shown in FIG. 11; and

FIG. 13 is a top plan view of the locking device 70 shown in FIG. 7 mounted on a cartridge housing 20 such as shown in FIG. 3.

### DETAILED DESCRIPTION OF PREFERRED EMBODIMENTS

In the practice of the present invention, the security feature of the inventive bayonet attachment system may take the form of, for example, a mechanical, structural element that assists in permanently retaining the two bayonet portions of the personal respiratory device together. In one embodiment, one or both portions of the personal respiratory protection device may include an element(s) that provides the security feature for a permanent bayonet connection. That is, the security feature may be integral with or integrated into one or both of the bayonet portions. The term “integral” is used herein to mean manufactured as a single part. The term “integrated into” means the security feature may be made separately but is subsequently joined together to form a single part. After the first portion and the second portion of the bayonet attachment system have been locked, the bayonet connection cannot be opened without destroying one of the first portion, the second portion, or both. Preferably, only one of the portions is destroyed. The security feature may be part of a system that is designed so that a key or tool, acting on the personal respiratory device, is used to unlock the bayonet connection.

In another embodiment, the personal respiratory protection device uses a third piece as the security feature, in addition to the two portions of the respirator with bayonet attachment, to provide a permanent bayonet connection. After the first portion and the second portion of the bayonet attachment system have been locked, in conjunction with the third part, the bayonet connection cannot be opened without destroying at least one of the first portion, the second portion, or the third part locking device. Preferably, either the locking device or one of the first or second portions is destroyed or a combination of the components. The security feature may be part of a system that is designed so that a key or tool, acting on the personal respiratory device or the third-piece locking device, is used to unlock the bayonet connection.

Preferably, the portion that is destroyed is on the filter cartridge. This would enable the mask to be reused. Although the inventive security feature can be used to couple or join various respiratory components together, the bayonet attachment system described below is shown applied to a half-face respirator that uses filter cartridges.

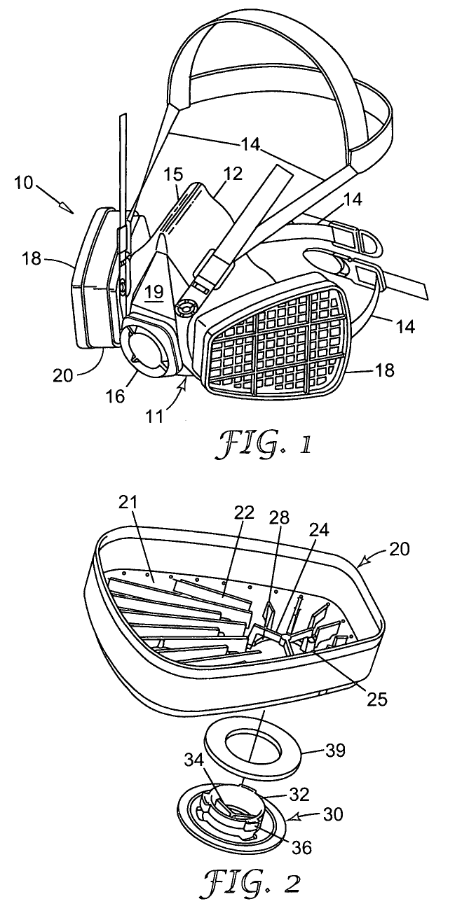

FIG. 1 shows a respiratory mask 10 that has a mask body 11 that includes a soft, compliant face piece 12, molded to follow the contours of a wearer's face. A harness that includes adjustable straps 14 secures face piece 12 to the wearer's head and minimizes any slippage or other undesired movement of the mask 10 when properly mounted to a person's head. Examples of harnesses that may be used on a respiratory mask are shown in U.S. Pat. Nos. 5,464,010, 6,199,692, and 6,591,837B1 to Byram, and U.S. Pat. No. 6,457,473 to Brostrom et al. Face piece 12 also includes a shaped nose ridge 15 for sealingly fitting the mask over the nose of a wearer.

On each side of the mask body 11, approximately over the wearer's cheek, is a cheek aperture (not shown) to allow transfer of non-contaminated air into the mask interior. To substantially minimize, and preferably eliminate, contaminants in the air from being inhaled, a non-contaminated-breathing-gas supply source such as filter cartridges 18 are operably positioned in fluid communication with each aperture. The filter cartridges 18 thus separate the ambient external air space from the interior gas space that resides between the mask body 11 and the wearer's nose and mouth. Cartridge 18 is designed to filter either particulate contaminants or vapors, or both, from the air that passes through the apertures. Air that passes through the aperture therefore first passes through cartridge 18 before entering the wearer's respiratory system. Alternatively, a hose from a PAPR or SCBA could be attached or otherwise be placed in fluid communication with the aperture to provide a non-contaminated air or oxygen to a wearer.

Air exhaled by the wearer exits the mask interior through outlet valve 16 located at the center front of the mask 10 on a rigid nosepiece or insert 19. Outlet valve 16 is a unidirectional valve that only allows exiting air to pass therethrough. The outlet valve may be a conventional button style valve or it may be a cantilevered or flapper valve such as the valves shown in U.S. Pat. Nos. 5,325,892 and 5,509,436 to Japuntich et al. or RE37,974E to Bowers. As described above, air entering mask 10 passes through the aperture and filter cartridge 18. A mask body 11 that has a rigid insert 19 supporting a compliant facepiece 12 is described in U.S. Pat. No. 5,062,421 to Burns and Reischel.

The filter cartridges 18 are joined to the mask body 11 through a bayonet attachment system.

Cartridge 18, in particular housing 20 of cartridge 18, defines a first portion of the bayonet attachment system. The first portion is configured for attachment to a second portion of the bayonet attachment system. Details regarding the first and second portions of the bayonet attachment system are described below.

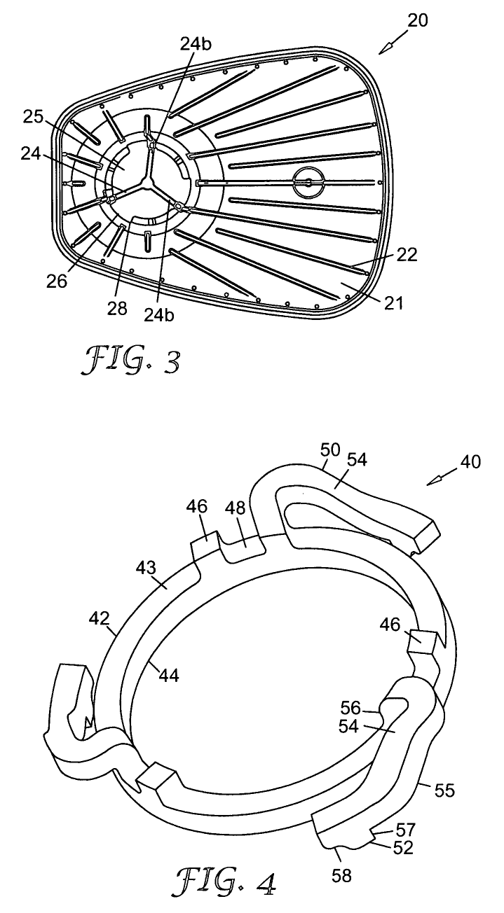

FIGS. 2 and 3 show the detailed interior of cartridge housing 20 having a bayonet type attachment system. The cartridge housing is typically a molded plastic structure that provides structural support for the filter media placed in the cartridge. The bottom 21 of housing 20 has a plurality of vanes 22 radially extending from an aperture 25 to provide a plenum or air channels through which air travels. Inhaled air will flow through aperture 25 after being filtered.

One typical and common filter cartridge, designed for removing organic vapors from the air, utilizes granulated charcoal particles as the media within the cartridge. Granulated charcoal, and other sorbent material, adsorb or absorb chemical contaminants (such as acids, bases, NOx, etc.). To produce such a filter cartridge, the general procedure includes providing at least one layer of fabric, for example, knitted, woven, or non-woven material, as the bottom layer in the housing. The housing is filled with granulated charcoal or other adsorbent material and pressure is applied to tightly compact the material. It is desired to have as dense of a packing as possible, with little or no space between the individual granules, in order to increase the contaminant removal efficiency of filter cartridge. Usually after the sorbent material has been compacted, at least one more fabric layer(s) is placed over the outer surface of the carbon. A cover is then secured to housing. The resulting assembled cartridge may be attached to the mask body.

Often, the pressure created by the packed sorbent media is sufficiently large to cause both the cover and the housing bottom 21 to bulge out somewhat. Because of this pressure, radial ribs 24 may be positioned within the aperture area 25 of the housing to provide further support for the bottom fabric layer so that the fabric and activated carbon do not pass through the aperture. Although three intersecting ribs 24 are shown in FIGS. 2 and 3, the number of ribs 24 may be increased or decreased, or an alternative design could possibly be used. U.S. Pat. No. 6,277,178B1 to Holmquist-Brown et al., for example, describes the use of a bonded sorbent filter element that is pressed against the inner surface of the filter cartridge. A folded edge on the cartridge side-wall holds the bonded sorbent filter media in place. Examples of sorbent media that could be used in the filter cartridge are described in U.S. Pat. No. 5,033,465 to Braun, U.S. Pat. Nos. 5,344,626 and 5,496,785 to Abler, U.S. Pat. No. 6,344,071B1 to Smith et al., and U.S. Pat. No. 6,391,429B1 to Senkus et al. Examples of nonwoven woven fibrous filter media that could be used in the cartridge are shown in U.S. Pat. No. 5,763,078 to Braun et al., U.S. Pat. No. 6,119,691 to Angadjivand et al., U.S. Pat. Nos. 6,213,122B1 and 6,319,452B1 to Rousseau et al., U.S. Pat. Nos. 6,397,458B1 and 6,409,806 to Jones et al., and U.S. Pat. No. 6,627,563B1 to Huberty.

The filter cartridge 18 shown in FIG. 1 can be cooperatively attached to mask body 11 by a fluid communication component that is disposed in fluid communication with the mask body so that a non-contaminated source of oxygen (including clean air) can be supplied to a wearer of the respiratory mask. An attachment fitting 30 (FIG. 2) located in the cheek area of mask body 11 may be used for this purpose. Attachment fitting 30 is often integral with face piece 12, that is, it is made as a single part with the rigid insert 19. Using a new method, however, fitting 30 can be made separate from the main portion of rigid insert 19 and can be subsequently attached to it (see U.S. patent application Ser. No. 10/719,959 filed on Nov. 21, 2003, by Flannigan et al.).

FIG. 2 shows attachment fitting 30, comprising a ring-like body 32 that has a plurality of tabs 36 extending radially therefrom. Ribs 34 may be present in body 32 to increase its strength and stability. Body 32, including tabs 36, are dimensioned to fit within aperture 25 of housing 20.

FIG. 3 shows that the aperture 25 includes an inwardly directed indent or notch 26, which notch 26 extends radially into housing 20 from aperture 25. Each notch 26 is shaped and configured to allow at least one tab 36 (FIG. 2) to be inserted into the notch 26 through aperture 25. Notch 26 defines a void that is sized to allow tab 36 (FIG. 2) to pass into its void space. Each notch 26 and tab 36 has a size, which is a function of the width and depth of notch 26 and tab 36, respectively. The width of notch 26 and tab 36 is measured along a radius of housing 20 and body 32, respectively, and the depth of notch 26 and tab 36 is measured from a central point of housing 20 and body 32. Typically, the size of notch 26 will be greater than the size of tab 36, to allow tab 36 to readily fit within notch 26 as shown in FIG. 1.

To attach a filter cartridge 18 to the mask body 11, the filter cartridge 18 and mask body 11 are brought together so that attachment fitting 30 is axially aligned with the aperture 25 such that tabs 36 fit within the void of notches 26. Cartridge 18 and mask body 11 are manipulated so that the body 32 and the tabs 36 of fitting 30 pass into and through notches 26 and aperture 25 of cartridge housing 20. As shown in FIG. 2, a gasket 39 may be positioned between cartridge 18 and fitting 30 to provide a cushion and a better seal between the two parts. After cartridge 18 is fitted over tabs 36 so that tabs 36 fit within notches 26, the cartridge 18 is rotated, typically about 20 to 90 degrees, depending on the design, to seat or lock cartridge 18 onto fitting 30. The cartridge rotation displaces tabs 36 from notches 26 to a tab engagement receptacle, described below, thereby not allowing cartridge 18 to be removed from the fitting 30 unless cartridge 18 is rotated back to where tabs 36 and notches 26 align.

As shown in FIGS. 2 and 3, tabs 36, and the corresponding notches 26, may be irregularly spaced around the fitting 30 and the aperture 25, respectively. Such a tab arrangement provides only one position in which the cartridge 18 can be placed on attachment 30. Such a notch/tab configuration can be beneficial for a non-circular filter cartridge that requires only one position for cartridges on the mask. Each tab 36 and its corresponding notch 26 may be differently shaped and/or sized to provide limited placement positions of cartridge 18 on attachment 30. Alternately, tabs 36 and corresponding notches 26 may be regularly spaced, to allow multiple positions of attachment, if, for example, the filter cartridge was circular or cylindrical in shape.

As indicated above, the present invention can eliminate the possibility of inadvertent removal of cartridge 18 from mask 10. This can be accomplished, in one embodiment, by using an optional locking element in conjunction with the tab/notch system of the bayonet connection just described.

The locking feature also may be integral with or integrated into the cartridge housing 20. If the system employs a third component as an optional part for achieving a permanent connection or demand or when desired, it may be a non-integral or separate device (i.e., a third piece) that can be inserted into an existing or conventional bayonet systems to permanently lock bayonet cartridge 18 to attachment 30 on mask 10. Destroying one or more of the pieces may provide two or three pieces, however, the pieces would not be in their initial original state. When utilizing a separate locking feature of the present invention, housing 20 is mechanically locked to, and is not removable from, attachment fitting 30 once the two arts have been joined together, unless perhaps a key is employed as described in more detail below. Housing 20 thus is removable from attachment fitting 30 only by destroying one of the housing 20, the attachment fitting 30, the inserted locking element, or a combination thereof.

FIG. 4 shows a locking element 40 that can be used to provide a permanent connection for a bayonet system when such a connection is desired by the wearer or the wearer's workplace. Locking device 40 uses ribs 24 of cartridge housing 20 to fixedly lock cartridge 18 to mask body 11. Locking device 40 is a ring structure that has a ring-like body 42 with a top side 43 and a bottom side 44. Located on top side 43 are rib-engaging structures, protrusions 46 and arms 50. Between protrusion 46 and arm 50 is a land area 48 onto which rib 24 may seat. The number of rib-engaging structures, or rib-retainers, e.g., pairs of protrusions 46 and arms 50, is preferably the same as the number of ribs 24 and tabs 36. In some embodiments, however, it may be desired to not have the same number but to have the number of arms 50 related to the number of tabs 36, for example, two arms 50 and four tabs 36, or six arms 50 and three tabs 36, etc. Similarly, the number of lands 48 should either match with, or relate to, the number of ribs 24. Three or more land 48/rib 24 and arm 50/tab 36 engagements may be used, however, one engagement of each type is sufficient to provide a secure lock or permanent connection.

Arm 50 is spaced from protrusion 46 to provide the land area 48. Land area 48 may have a slightly curved surface, such as shown in FIG. 4, or may have clean right angles. Each arm 50 has a base section 56 that may be similar in size and shape to protrusion 46 or may be different. Base section 56 may extend away from top side 43, approximately the same distance as protrusion 46—that is, the height of the base 56 may be approximately the same as the height of protrusion 46, however, any ratio for height of base 56 to protrusion 46 could be used. From base 56, arm 50 progresses to a ramp section having a top ramp surface 54 and bottom ramp surface 55. The ramp extends away from protrusion 46 and slopes toward bottom side 44 of locking device 40. In some embodiments, the arm 50 does not extend below bottom side 44 but extends with at least a portion of bottom ramp surface 55 extending below bottom side 44. Arm 50 should be slightly flexible, resilient, or the like. Preferably, arm 50 pivots or at least flexes minimally axially (that is, from top ramp surface 54 to bottom ramp surface 55 and vice versa) from base 56. In one embodiment, at the end of the ramp, top ramp surface 54 is approximately coplanar with top side 43. At the end of bottom ramp surface 55 is stop 52. Stop 52 has a flat surface 57 facing the direction of protrusion 46, and a sloped surface 58 facing away from the direction of protrusion 46.

Locking device 40 is designed to be installed so that top side 43 is facing cartridge housing 20 (FIG. 2) or the female portion of the bayonet connection. In particular, once installed on filter cartridge 18, rib 24 of housing 20 is retained on a rib-retainer seated in land area 48 between protrusion 46 and arm 50. With this configuration, locking device 40 is positioned on housing 20 without the ability to move significantly—that is, locking device 40 cannot be rotated either clockwise or counterclockwise for any appreciable distance.

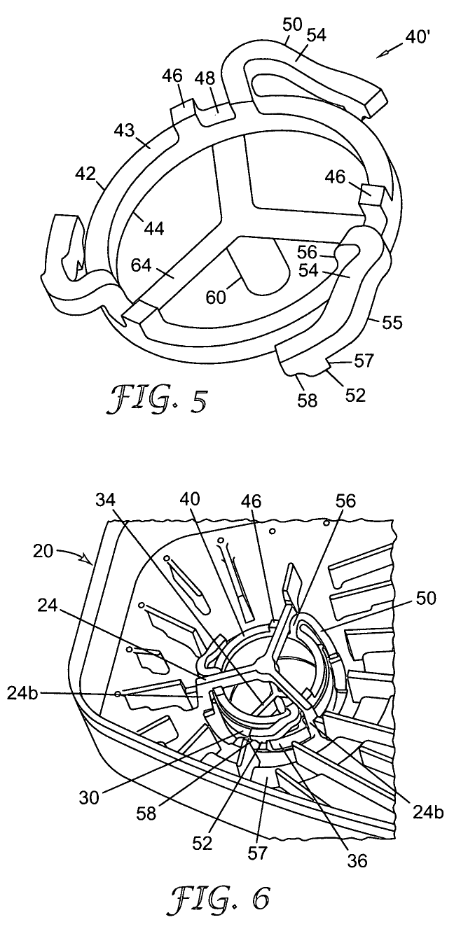

Locking device 40 may have a handle thereon to facilitate placing and positioning of device 40 on to ribs 24. An example of a suitable handle is a centrally located grippable protrusion or handle 60 such as shown in FIG. 5 on locking device 40′. Handle 60, connected to body 42, extends away from bottom side 44 and is supported by radial supports 64. Although radial supports 64 are shown in FIG. 5 as connecting to body 42 in the proximity of protrusions 46 and arms 50, radial supports 64 can be positioned anywhere along body 42.

FIG. 6 shows locking device 40 positioned within cartridge housing 20 and then locked onto male attachment fitting 30. Locking device 40′ shown in FIG. 5 would be likewise positioned within the cartridge housing 20. FIG. 6 shows the arrangement from the perspective from the interior of housing 20 looking in the direction of the mask body 11. That is, the attachment portion of housing 20 would be positioned adjacent the rigid insert 19 (FIG. 1) of mask body 11. Locking device 40 or 40′ would be positioned between housing 20 and male fitting 30, which would be on the rigid insert 19 of mask body 11.

Locking device 40, 40′ permanently fixes cartridge 18 in relation to fitting 30. As shown in FIG. 6, locking device 40 is positioned so that ribs 24 of cartridge housing 20 are seated on land 48 (FIGS. 4 and 5) between protrusion 46 and base 56 of arm 50. Because of such positioning, locking device 40, 40′ is fixed in relation to cartridge 18 and cannot appreciably rotate in either direction, nor can locking device 40, 40′ move inward into the media of the cartridge. Likewise, locking device 40, 40′ is in fixed relation to the male fitting 30 of mask body 11. Tab 36 of fitting 30 is positioned against rib 24 (or a base thereof) and is held against rib 24 by arm 50 of locking device 40, 40′. Tab 36 is unable to rotate counterclockwise because of base 24b of rib 24. Stop 52, and in particular flat surface 57 of stop 52, eliminates possible clockwise rotation of tab 36 because tab 36 abuts flat surface 57. Thus, locking device 40, 40′ fixedly secures and retains the relative position of cartridge ribs 24 in relation to attachment fitting tabs 36.

To attach cartridge 18 using locking device 40, 40′ to mask 10, cartridge 18 is seated onto fitting 30 in the overall same manner as if no locking device were present, except that locking device 40, 40′ is disposed on ribs 24 of housing 20. Fitting 30 is aligned with aperture 25 in housing 20 so that fitting tabs 36 align with notches 26 in aperture 25. Cartridge 18 and mask body 11 are brought together so that fitting body 32 and fitting tabs 36 pass into and through aperture 25. After cartridge 18 is fitted over tabs 36 and is seated on attachment 30, cartridge 18 is rotated sufficiently to adequately join together the first and second portions of the bayonet connection. The locking devices of the present invention can be designed to engage and lock bayonet constructions that operate using clockwise or counterclockwise rotation.

During tab 36 rotation, tab 36 contacts sloped surface 58 of locking device 40, 40′ and pushes sloped surface 58 and arm 50 over tab 36 so that tab 36 can move to the laterally relative to stop 52—see FIG. 6. Once on a lateral side of stop 52, tab 36 abuts flat surface 57. Tab 36 is unable to move in the opposite direction because it is bounded by flat surface 57. Tab 36 also is unable to move in the rotated direction because it is bounded by rib 24 and rib base 24b.

When housing 20 is permanently locked onto fitting 30, tab 36 cannot be moved from its placement between stop 52 of locking device 40, 40′ and rib 24 of housing 20 without breaking rib 24, stop 52, or some other part of locking device 40, 40′. The housing and locking mechanism as described also may be adapted so that a key or tool could be used to disengage the lock and remove the cartridge from the mask.

To disengage stops 52 from tabs 36, a tool with pins that would protrude through the bottom of housing 20 could be used to lift arms 50. By lifting arms 50, stops 52 would be disengaged from tabs 36, releasing the locking mechanism and permitting the cartridge to be rotated off. It is important to note that if a pin type tool is used to engage and lift arms 50, a structural provision must be made in the housing to allow the pin to pass through the wall of the housing while maintaining seal integrity during normal use of the cartridge. This structural provision might be a septum or a designed weakness (e.g., a penetrable rubber seal) in the housing through which the pin of the tool could be made to hermetically penetrate. Depending on the configuration of the locking mechanism, any number of tool or key designs could be adapted to release the lock mechanism while preserving the seal integrity of the cartridge.

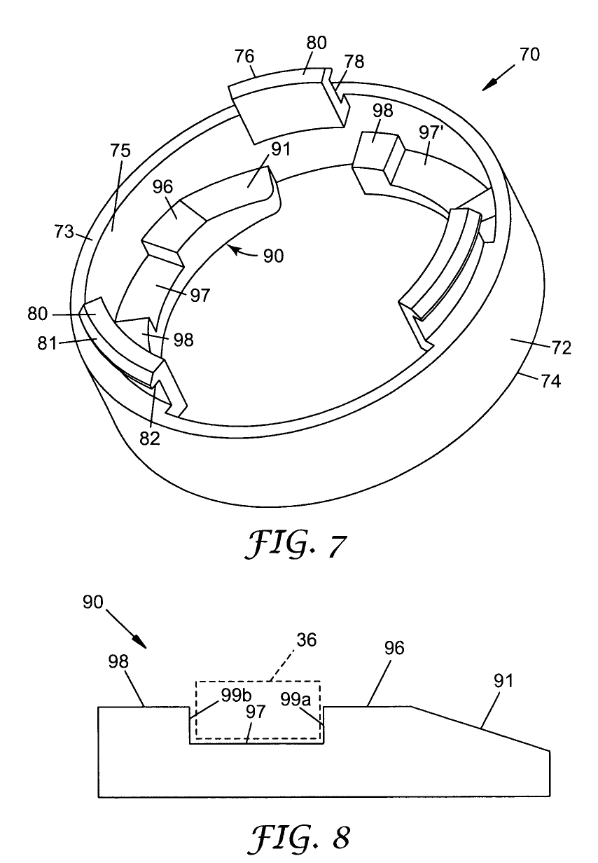

FIG. 7 shows another embodiment of a non-integral locking device 70. Unlike locking device 40, 40′, locking device 70 does not use ribs 24 of cartridge housing 20 to provide the permanent lock between cartridge 18 and attachment 30. Rather, locking device 70 uses the edge 28 of the aperture 25 (shown in FIG. 2) of housing 20. Locking device 70 is a ring structure that has a body 72 with a top side 73, a bottom side 74, and an interior wall 75. Located on top side 73 are catches 76 that have a recessed portion 78. Catch 76 has a top edge 80 and a ramp portion 81 sloping outward and downward from top edge 80. Catch 76 further has an interior lip 82 that forms the top of recessed portion 78.

A catch mechanism 90 is positioned on interior wall 75, near bottom side 74. Preferably, the catch mechanisms 90 are alternately spaced with catches 76. Catch mechanism 90 has a ramped portion 91 extending to a first flat portion 96. First flat portion 96 and second flat portion 98 have land 97 therebetween. Flat portions 96 and 98 may be parallel to land 97 in non-alignment with flat portions 96 and 98. Land 97 may be closer to bottom side 74 than flat portions 96 and 98. Or, flat portions 96 and 98 may be non-planar, with land 97 positioned below both flat portions 96, 98.

As best shown in FIG. 8, land 97 is bounded by walls 99a and 99b, which walls extend generally perpendicular to flat portions 96 and 98 respectively. Together, land 97 and walls 99a and 99b define a tab receiving receptacle configured to accept and retain tab 36, shown in phantom.

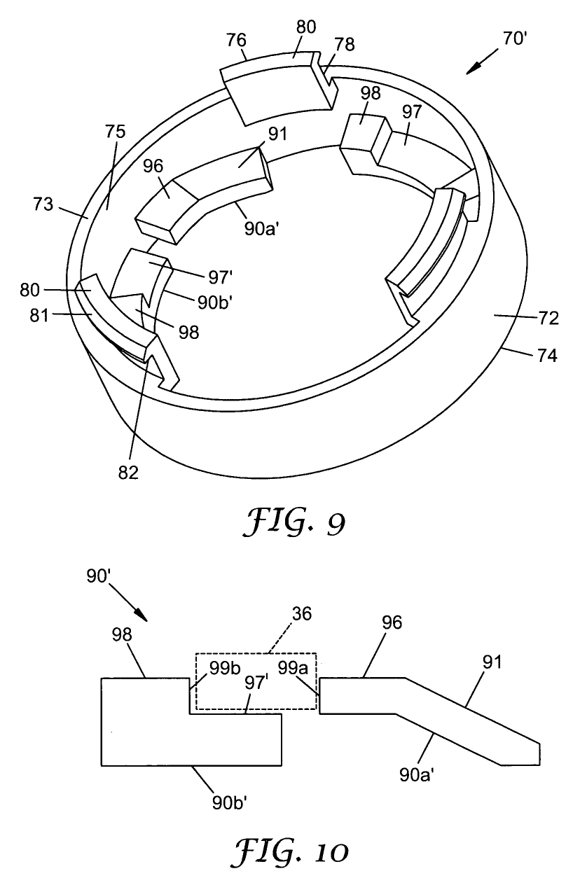

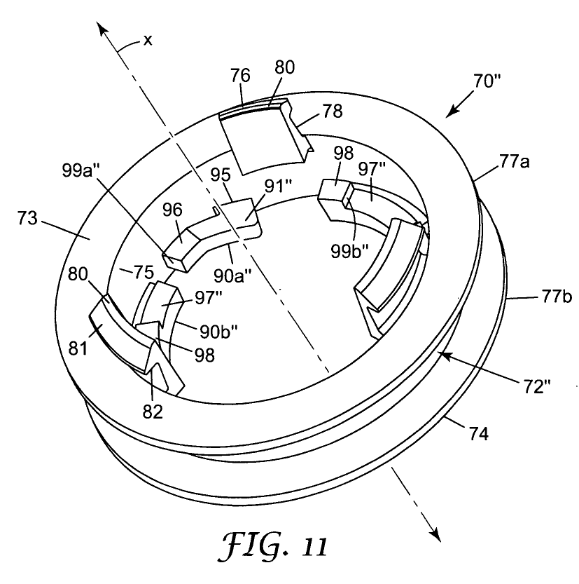

FIGS. 9 and 10 illustrate locking device 70′, which is similar to locking device 70 except that instead of catch mechanism 90, locking device 70′ has catch mechanism 90′ that includes a separate catch feature 90a and catch base 90b. Locking device 70′ is a ring structure having a body 72 with a top side 73, a bottom side 74, and an interior wall 75. Located on top side 73 are catches 76 that have a recessed portion 78. Catch 76 has a top edge 80 and a ramp portion 81 sloping outward and downward from top edge 80. Catch 76 further has an interior lip 82 that forms the top of recessed portion 78.

Opposite catches 76, near the bottom side 74, are catch feature 90a′ and catch base 90b′, shown enlarged in FIG. 10. Preferably, catch feature 90a′ and catch base 90b′ are alternately spaced with catches 76. Catch feature 90a′ has a ramped leading portion 91 that extends to a first flat portion 96. First flat portion 96 on catch feature 90a′ and second flat portion 98 on catch base 90b′ have a land 97′, similar to land 97 of locking device 70, therebetween. Flat portions 96 and 98 may be parallel to land 97′ and non-aligned with flat portions 96 and 98. Alternately, flat portions 96 and 98 may be non-aligned. Land 97′ is bounded by walls 99a′ and 99b′ (shown in FIG. 10), which walls extend vertically to flat portions 96 and 98, respectively. Land 97′ and walls 99a and 99b define a tab receptacle that is configured to accept and retain tab 36, shown in phantom in FIG. 10.

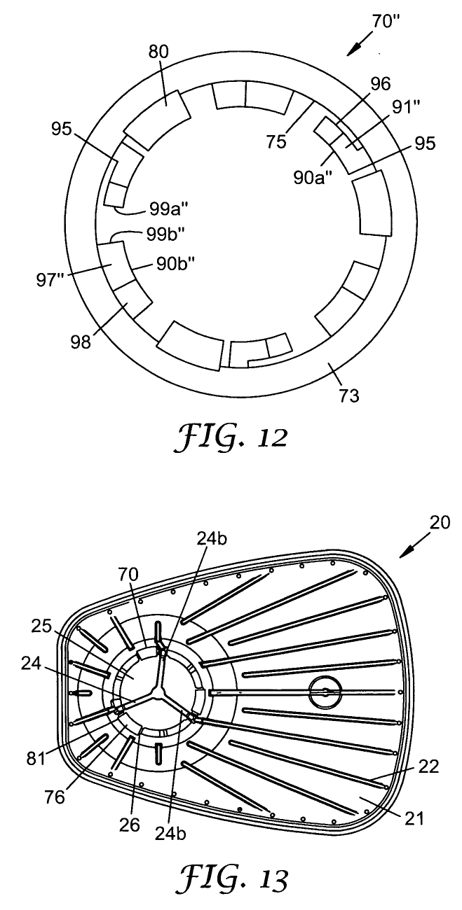

FIGS. 11 and 12 show yet another locking device 70″, which is similar to locking device 70 and locking device 70′, except that spring catch 90a″ of locking device 70″ is attached to interior wall 75 of device 70″ at only one ramp end 95 of ramped leading portion 91″. Spring catch 90a″ is thus able to function as a spring, that is, it is capable of flexing so as to facilitate moving of tab 36 thereover. Spring catch 90a″ flexes in the general direction of axis x when receiving a force from tab 36 as it moves rotationally about axis “x” over ramped surface 91′. Spring catch 90a″ attaches to interior wall 75 at ramp end 95. Other than the attachment at ramp end 95, spring catch 90a″ is extended from interior wall 75. Locking device 70″ also is a ring structure having a top side 73, a bottom side 74, and an interior wall 75. Body 72″ of locking device 70″ includes axially spaced ledges 77a and 77b. Ledges 77a and 77b extend radially outward from body 72″, typically several millimeters. Ledges 77a and 77b are provided for placement of gaskets or other such structures which may improve the sealing of locking device 70″ between fitting 30 and filter cartridge 18 (FIGS. 1 and 2). Located on top side 73 are catches 76 that have a recessed portion 78. Catch 76 has a top edge 80 and a ramp portion 81 sloping outward and downward from top edge 80. Catch 76 further has an interior lip 82 that forms the top of recessed portion 78. Opposite catches 76, near the bottom side 74, are spring catch 90a″ and catch base 90b. The side view of spring catch 90a″ and catch base 90b″ would be very similar to, if not the same as, catch feature 90a′ and catch base 90b′ of locking device 70′, which is shown in enlarged view in FIG. 10. Preferably, spring catch 90a″ and catch base 90b″ of locking device 70″ are alternately spaced with catches 76. Spring catch 90a″ of device 70″ in FIGS. 11 and 12 has a ramped leading portion 91″ connected to interior wall 75 at ramp end 95 and extending to a first flat portion 96. The end of spring catch 90a″ opposite ramp end 95 is not connected to interior wall 75 in the embodiment of FIGS. 11 and 12. First flat portion 96 on spring catch 90a″ and second flat portion 98 on catch base 90b″ have land 97″ therebetween. Flat portions 96 and 98 may be co-planar with land 97″ is positioned below flat portions 96 and 98. Similar to locking device 70′ shown in FIG. 10, land 97″ would be bounded by walls 99a″ and 99b″. Land 97″ is constructed and arranged to retain tab 36 thereon. Because of the attachment of spring catch 90a″ to interior wall 75 only at end 95, spring catch 90a″ can be easily deformed to allow easier passage of tab 36 over spring catch 90a″ and onto land 97″.

Locking devices 70, 70′, 70″ are designed to be installed so that top side 73 of device 70, 70′, 70″ faces cartridge housing 20, similar to how top side 43 of locking device 40, 40′ faces cartridge housing 20. Upwardly extending catch 76 is sufficiently flexible to allow deflection radially inward so that catch 76 with ramp portion 81 can move axially towards the interior of housing 20 to engage edge 28 of notch 26 of aperture 25. With adequate axial penetration, lip 82 snaps on to edge 28 and locks device 70, 70′, 70″ on to housing 20.

FIG. 13 shows an interior view of housing 20 with locking device 70 (or equally 70′, 70″) snapped thereon. Catch 76 has engaged edge 28 (FIGS. 2 and 3) of aperture 25 at notches 26. Edge 28, and optionally rib base 24b, retain catch 76 within notch 26 and eliminate rotation of locking device 70. With this configuration of catch 76 locked in notch 26, locking device 70 is positioned on housing 20 so that locking device 70 cannot be moved upward, downward, or rotated within aperture 25. As shown in FIG. 13, the interior wall 75 (shown in FIGS. 7 through 12) aligns with aperture 25 so that only catches 76 of locking device 70 are mainly visible in FIG. 13.

To attach a filter cartridge 18 with locking device 70, 70′, or 70″ permanently attached thereon to a mask body 11, cartridge 18 and fitting 30 are aligned so that tabs 36 align with the gaps between catch mechanism 90 (or between catch feature 90a and catch base 90b of non-pairs). Cartridge 18 and mask body 11 are brought together and engaged so that fitting body 32 and tabs 36 pass into and through the gaps between catch mechanisms 90. Once locking device 70, 70′, 70″ is fitted over tabs 36 and is seated on fitting 30, cartridge 18 is rotated so that tab 36 contacts ramp 91 of locking device 70 and slides up ramp 91, over flat portion 96, and seats on land 97. For locking device 70′, 70″ with spring catch 90a′, 90a″, tab 36 rotates to slide up ramp 91 and force spring catch 90a′, 90a″ axially relative to fitting body 32 and locking device body so that tab 36 can move to the other side of and over catch feature 90A and seat on land 97, 97′. Once seated on land 97, 97′, tab 36 is unable to rotate because it is bounded by wall 99A on one side and wall 99B on the other side.

Housing 20 of cartridge 18 is now permanently locked onto mask 10 and attachment 30. Tab 36 of attachment 30 cannot be removed from its placement between walls 99A and 99B without breaking catch mechanism 90 or some other part of locking device 70, 70′, 70″.

It should be noted that locking devices 40, 40′, 70, 70′, 70″ function in the same manner by engaging tab 36 between protrusions or walls that do not allow tab 36 to rotate. Locking device 40, 40′ functions by being placed within cartridge housing 20, whereas locking devices 70, 70′, 70″ are placed between housing 20 and fitting 30, providing an extension of the filter cartridge 18 away from the fitting 30.

The locking mechanism can also be adapted to incorporate various features of the above-described locking mechanisms but without a ringed body. For example, the locking mechanism may be a polygon that allows the first half of the bayonet system to be rotated relative to the second half. The body of the locking mechanism also may be a portion or segment of a ring, for example, a 150° ring segment. Such ring segments would be fashioned to function in the same manner as full ring bodies, by engaging tab 36 in fixed relation with portions of the locking mechanism and thus eliminating further rotation.

The features of a locking device, such as devices 40, 40′, 70, 70′, 70″ can alternately be incorporated into either portion of the bayonet attachment system, either on the filter cartridge 18 or on the mask body 11, thus eliminating the need for a third-piece locking device. To not give the user the option of permanently attaching the filter cartridge, the locking device may be incorporated into the mask body. To provide a permanent connection option, the locking device features may be incorporated into the filter cartridge 18 (or a separate optional part such as parts 40, 40′, or 70). The user could then select cartridges that have a permanent locking feature or cartridges that do not, depending on, for example, the environment in which the mask is intended to be worn. A non-permanent connection may be desired when the ambient environment is not critically hazardous and the user may want to be able to recycle or reuse the mask body when the cartridge has met the end of its service life.

Referring to locking device 70 in FIGS. 7 and 8, a cartridge 18 could be designed with catch mechanism 90, which catch includes flat portions 96, 98, walls 99a, 99b (which form a receiving receptacle), integral with housing 20. Such an integral construction eliminates the features used to fixedly mount locking device to cartridge 18, features such as those present at top side 73. Housing 20 could be provided with a catch mechanism 90 that has a ramped portion 91 extending to first flat portion 96. Land 97 would be present between first flat portion 96 and second flat portion 98 and bounded by walls 99a and 99b. This receiving receptacle would be configured to accept and retain tab 36 (shown in phantom in FIG. 8) as the third-piece locking device 70.

Cartridge 18 could alternately be designed with features from third-piece locking device 70′ (FIGS. 9 and 10) integrally formed in housing 20. For example, the cartridge housing 20 could include separate catch feature 90a′ and catch base 90b′ for receiving and retaining a tab 36. Catch feature 90a′ would include first flat portion 96 and catch base 90b′ would have second flat portion 98. Between catch feature 90a′ and catch base 90b′ is land 97′. Land 97′ is bounded by walls 99a′ and 99b′ (shown in FIG. 10) to define a receptacle configured to accept and retain tab 36 (shown in phantom in FIG. 10).

In yet another design, cartridge 18 could have features from third-piece locking device 70″ (FIGS. 11 and 12) integrally formed in housing 20. That is, spring catch 90a″ of locking device 70″ could be attached to interior wall 75 of aperture 25 at only one ramp end 95 of ramped leading portion 91′.

The discussion of the security features of the bayonet attachment system have been discussed above as having a permanent connection, which cannot be disengaged or unlocked without breaking or otherwise damaging one or both of the bayonet portions. In some embodiments, depending on the design of the security features, the connection system can be unlocked by a separate key or tool. Preferably, the key is specifically designed to engage the security feature and release the permanent connection. For example, the key would be specially designed to engage with and unlock the connection. In some designs, a common tool such as a screwdriver or pick could be used to unlock the connection, however, in embodiments where strict control of the usage of respirator cartridges or the like is desired, a specially designed key may be preferred, so that items readily available to the user are not used to unlock the connection. The key could be retained by a person who supervises respiratory wearing and maintenance. The key could operate by being inserted into a corresponding opening in the cartridge housing or mask body to engage the locking mechanism. The key could disengage the locked bayonet connection by turning, by prying, or by pushing. The key could have a particular cross-section that corresponds to the recess in which it fits. The key could be square, rectangular, or be further multi-sided such as 5-, 6-, 7-, or 8-sided to disengage the locked bayonet system. The key could also be purely circular in cross-section and thus operate by pushing or could have certain protuberances located thereon to operate by turning or prying. It is preferred that a user not merely using their fingers or teeth to unlock the connection. Use of an incorrect key or tool would preferably result in a damaged or destroyed connection.

In addition to the structure features of the locking device that permanently connect the portions of the bayonet attachment, system, one or both of the portions could include mechanical surface features present on one or both bayonet portions. Examples of suitable features include hook and loop (for example, such as disclosed in U.S. Pat. No. 6,558,602 (Melbye et al.), which is incorporated herein by reference), microreplicated surfaces (for example, such as disclosed in U.S. Patent Publication No. U.S. 2003/0088946 A1, (Ferguson et al.) and in U.S. Pat. No. 6,546,604 (Galkiewicz et al.), or other mechanical fasteners. A useable alternative to pure mechanical elements is an aggressive adhesive present between the bayonet portions. The adhesive could be activated when the two portions are engaged.

Various embodiments of the bayonet attachment system of this invention are not limited to use with cartridge housings 20 having hard plastic (or metal) structures. Any of the locking devices, and versions thereof integral with housing 20, can be used with a soft, non-woven filter (for example, one commercially available from 3M under the trade designation “2078” Filter P95 Particulate) that lacks such a rigid housing. These non-woven filters can be attached to face mask 10 using the same bayonet style attachment system.

The invention also is not limited to use with the half mask respirator illustrated in the drawings. The invention may also be suitably used in a fill face mask (see, for example, U.S. Pat. No. 5,924,420 and Des. 378,610 to Reischel et al.) in a PAPR (see, for example, U.S. Pat. No. 6,186,140B1 to Hogue, U.S. Pat. No. 6,575,165B1 to Cook et al., U.S. Pat. No. 6,615,828B1 to Petherbridge, and U.S. Pat. No. 6,619,286B2 to Patel), in a hood (see U.S. Patent D480,476S to Martinson et al.), in a helmet system (see, for example, U.S. Patent D469,580S to Schlaefer et al.), or in a SCBA.

This invention may take on various modifications and alterations without departing from the spirit and scope thereof. Accordingly, it is to be understood that this invention is not to be limited to the above-described, but it is to be controlled by the limitations set forth in the following claims and any equivalents thereof.

It is also to be understood that this invention may be suitably practiced in the absence of any element not specifically disclosed herein.

All patents and patent applications cited above, including those in the Background section, are incorporated by reference into this document in total.

1. A personal respiratory protection device that comprises:
(a) a mask body that is adapted to fit at least over a person's nose and mouth;
(b) at least one fluid communication component located in fluid communication with the mask body so that a non-contaminated source of oxygen can be supplied to a wearer of the personal respiratory protection device;
(c) at least one non-contaminated breathing gas supply source component; and
(d) at least one bayonet attachment system that enables the breathing gas supply source component to be fluidically communicatively secured to the fluid communication component, the bayonet attachment system comprising a first portion and a second portion, wherein when the first portion is attached to the second portion with a connection that is incapable of being inadvertently separated.

2. The personal respiratory protection device of claim 1 being a respiratory mask that has at least one filter cartridge as the at least one non-contaminated breathing gas supply source component.

3. The respiratory mask of claim 2, wherein the first portion of the bayonet attachment system comprises a tab receptacle and a tab void area, and wherein the second portion comprises a tab extending therefrom, the tab having a size no greater than the tab void area and no greater than the tab receptacle, wherein when the first portion is attached to the second portion to cause the tab to seat within the tab receptacle, a connection is formed that is incapable of being inadvertently removed.

4. The respiratory mask of claim 2, wherein the connection is permanent.

5. The respiratory mask of claim 2, wherein the connection can only be unlocked with a key.

6. The personal respiratory protection device of claim 1, wherein the bayonet attachment system further comprises a third part, wherein disengagement of the first portion from the second portion requires breaking the first portion, the second portion, the third part, and any part or combination thereof.

7. The personal respiratory protection device of claim 1, wherein the bayonet attachment system comprises a locking device that is integral with the first portion, the second portion, or a combination thereof.

8. The personal respiratory protection device of claim 1, wherein the bayonet attachment system comprises a locking device that is integrated into the first portion, the second portion, or a combination thereof.

9. The personal respiratory protection device of claim 1, wherein the connection can be separated through use of a key.

10. The personal respiratory protection device of claim 1, being a powered air-purifying respirator.

11. The personal respiratory protection device of claim 1, being a self-contained breathing apparatus.

12. The personal respiratory protection device of claim 1, being a full-face respirator.

13. The personal respiratory protection device of claim 1, being a supplied air hood.

14. The personal respiratory protection device of claim 1:
wherein the first portion further comprises a ramp portion; and
wherein the tab receptacle of the first portion is defined by a first wall and an opposite second wall, the first wall defined by the ramp portion.

15. The personal respiratory protection of claim 4, wherein the ramp portion comprises a spring mechanism and a first end, the first end defining the first wall of the tab receptacle.

16. The personal respiratory protection device of claim 5, wherein the ramp portion further comprises a second end opposite the first end, and wherein the ramp portion is attached to the inner surface at the second end.

17. The personal respiratory protection device of claim 1, wherein:
(a) the first portion has an aperture therethrough, and
(b) the second portion comprises a body having an aperture therethrough, the body configured for attachment to the first portion such that the first portion aperture aligns with the body aperture.

18. The personal respiratory protection device of claim 1, wherein:
(a) the first portion further comprises a second tab receptacle, a second ramp portion, and a second tab void portion; and
(b) the second portion further comprises a second tab extending from the body outer surface.

19. The personal respiratory protection device of claim 18, wherein the first portion further comprises a third tab receptacle, a third ramp portion, and a third tab void portion; and wherein the second portion further comprises a third tab extending from the body outer surface.

20. A personal respiratory protection device that has a bayonet attachment system, the bayonet attachment system comprising a first portion and a second portion, wherein:
(a) the first portion comprises a tab receptacle and a tab void area; and
(b) the second portion comprises a tab extending therefrom, the tab having a size no greater than the tab void area and no greater than the tab receptacle;
wherein when the first portion is attached to the second portion to cause the tab to seat within the tab receptacle, a connection is formed that is incapable of being inadvertently removed.

21. The personal respiratory protection device of claim 1, wherein the connection can only be unlocked with a key.

22. The personal respiratory protection device of claim 1, wherein the connection is permanent.

23. A method of making a personal respiratory protection device, which method comprises:
(a) providing at least one fluid communication component;
(b) providing at least one non-contaminated breathing gas supply source component;
(c) providing at least one bayonet attachment system that comprises a first portion and a second portion; and
(d) joining the first portion to the second portion to form a connection that is incapable of being inadvertently removed.

24. The method of claim 23, wherein the at least one fluid communication component comprises at least one fitting disposed on a mask body, and the at least one breathing gas supply source component comprises at least one filter cartridge.

25. A method of making a personal respiratory protection device, comprising:
(a) providing a first portion of a bayonet attachment system comprising a tab receptacle and a tab void area;
(b) providing a second portion of a bayonet attachment system comprising a tab extending therefrom, the tab having a size no greater than the tab void area and no greater than the tab receptacle; wherein when the first portion is attached to the second portion to cause the tab to seat within the tab receptacle, a permanent connection is formed,
(c) locking the first portion of the bayonet system with the second portion of the bayonet system by:
(i) passing the tab through the tab void area;
(ii) rotating the first portion in relation to the second portion; and
(iii) seating the tab within the tab receptacle.

26. A method of un-making a personal respiratory protection device, comprising the steps of claims 25 and further comprising:
(d) unlocking the first portion of the bayonet system from the second portion by using a key.

27. A method of un-making a personal respiratory protection device, comprising the steps of claims 25 and further comprising:
(d) removing the first portion of the bayonet system from the second portion by destroying at least one of the first portion and the second portion.
